(19) United States
(12) Patent Application Publication
(10) Pub. No.: US 2008/0305450 A1
(43) Pub. Date: Dec. 11, 2008

(54) PLACEMENT JIG FOR AN ORTHODONTIC DEVICE

(75) Inventor: Goran Steen, Hovas (SE)

Correspondence Address: YOUNG & THOMPSON, 209 Madison Street, Suite 500, ALEXANDRIA, VA, 22314, US

(73) Assignee: GESTENCO INTERNATIONAL AB, GOTEBORG (SE)

(21) Appl. No.: 11/758,682

(22) Filed: Jun. 6, 2007

(51) Int. Cl. A61C 7/02

(52) U.S. Cl. 433/3

(57) ABSTRACT

Described are orthodontic devices intended to be attached to a tooth and in particular to the positioning and handling of equipment intended to be fastened to the tooth. The orthodontic device includes a component adapted to be attached to a tooth and a placement jig. The placement jig is attached to the component at a connection so that the jig may be turned or twisted at the connection. The connection is adapted to be easily disconnected when the component is attached to the tooth. In another embodiment, an orthodontic device is provided with a holding stick which may aid in either positioning the orthodontic device or, in case of a self ligating bracket, opening a lid. The device is in particular useful for orthodontic devices to be placed at the lingual side of a tooth.

### TECHNICAL FIELD

The present invention relates to dental brackets and the like equipment intended to be attached to a tooth. In particular the invention relates to such equipment which is intended to be fastened at the lingual side of the tooth and the positioning and handling of such equipment.

### BACKGROUND ART

Positioning of dental or orthodontic brackets of various types on the teeth of a patient for correcting various irregularities is well known in the dental art. In older work, these brackets comprised a band to be placed around the teeth whereby each band were equipped with a protuberance to which wires and bands could be attached in order to link the system. Nowadays, brackets are commonly attached by cementing the base of the bracket where needed to the face of the teeth and thereby eliminating the need for bands encircling the teeth.

One common way of positioning the brackets is to first make a replica of the patient's teeth for pre-positioning of the brackets followed by the transfer of the brackets from the model to the patient's teeth. According to a well known method, the transfer may be made by the use of a single moulded cast to move all brackets as a unit from the dental cast to the patient's teeth. In this technique, the brackets are first put on the dental cast which is a replica of the patient's teeth. The next step is to make a positioner, or “tray”, by moulding around the brackets and the dental cast. The positioner is allowed to set and when it is removed, the brackets are removed with the positioner. This mould may thereafter be positioned on the patient's teeth whereby the brackets are cemented to the teeth. An example of such a method is disclosed in U.S. Pat. No. 4,501,554. This method usually works well but has the disadvantage of being somewhat complicated. In many cases, a dentist or an orthodontic clinic do not have the resources of making these models or being able to perform the transfer of the brackets to the positioner why the set up has to be sent away to a specialist. This procedure is generally time consuming and there is a need of several persons or institutes to be involved in the process. Even if there are in-house resources for making the positioner, there is still need for another step, i.e. the making of the positioner, to be processed when using this method.

According to another method, the brackets are removed from the model one by one and positioned one at a time on the patient's teeth. According to this method, there is no need for making the moulded positioner and the process can be performed easier. However, there is a difficulty in placing the brackets on the desired positions on the surface of the teeth. In particular, this is a problem when a lingual bracket shall be placed since it is more difficult to get a sufficient visual perception of how the bracket is placed while the positioning procedure is going on. There are several suggested methods for making this positioning correct by the use of different kinds of jigs. In U.S. Pat. No. 4,284,405, a method is described for positioning of individual brackets. According to this method, an individual positioning jig is formed for each bracket to be placed on a tooth by positioning the bracket at the desired location on a model of the patient's teeth. The jig is formed according to the contour of the crown and the surface where the bracket shall be located whereupon the jig and the bracket are placed on the patient's tooth. Even though this method may work in a desired way, the method is rather complicated and time consuming and may have similar disadvantages as discussed for U.S. Pat. No. 4,501,554. Other similar methods for positioning of individual brackets are described in U.S. Pat. No. 4,183,141 and U.S. Pat. No. 5,863,198.

In U.S. Pat. No. 4,523,908, a more simplistic placement jig is disclosed. The jig is adapted to hold the bracket and position the bracket on the surface of the teeth at a predetermined distance from the incisal edge of the tooth. When the bracket is located and attached at the right position, the placement jig is removed. A similar device is also disclosed in U.S. Pat. No. 4,626,208.

Even though these arrangements work well for certain applications they might be difficult to handle. First the bracket must be positioned right in the jig and there after removed. Especially in case of positioning the bracket on the lingual side of the tooth it is sometimes hard to remove the jig. Furthermore, the constructional features of these jigs make them not suitable to be used for the lingual side of the tooth since the lingual surface of the tooth differs many times from the buccal surface. Hence, there is a need for a better arrangement for handling a bracket, in particular lingual brackets, which gives a sufficient aid in positioning the bracket while it still does not involve costly details or procedures which are excessively time consuming.

In recent time, the use of self ligating orthodontic brackets has become more common. These brackets include a bracket base and a ligation cover which interacts with the base in order to provide ligation of an arch wire associated with the base. Such brackets are described in for example U.S. Pat. No. 6,655,957, U.S. Pat. Nos. 6,659,766 and 6,659,767. These brackets are usually provided with a locking mechanism which prevents the lid from opening when it is in its closed, ligating position. However, these brackets may be hard to open up sometimes and the better the closing is, the harder they are to open up. In particular for lingual brackets, which are harder to work with when located on the tooth, it might be a problem to open when desired. Hence, there is a need for making an improved arrangement for handling a bracket, in particular lingual brackets, which serves the purpose of making the open up of a closed self ligating bracket easier.

### DISCLOSURE OF INVENTION

In a first aspect of the invention, it relates to a placement jig for positioning of an orthodontic device, e.g. a bracket or another component intended to be attached to a tooth. According to the invention, the placement jig and the orthodontic device are connected to each other in such a way that the jig may be bent or turned in relation to the orthodontic device, before the jig is detached from the orthodontic device, in such a way that the orthodontic device easily may be located on the tooth at a desired location and having a desired angle with respect to the surface of the tooth while the placement jig is resting against a tooth for positioning of the orthodontic device.

This flexibility of the relation between the jig and the orthodontic device may for example be achieved by selecting a material which is flexible enough to allow some bending and turning of the jig, while the connection between the jig and the orthodontic device is deformed plastically, before the connection is broken, e.g. by bending the jig back and forth several times when the orthodontic device is securely attached to the tooth. It is also preferred that the dimensions of the part connecting the jig and the orthodontic device is adapted to allow a sufficient flexibility to make it easy to adjust the jig and the orthodontic device relatively each other.

It would of course be possible to make the connection by other arrangement such as hinges, ball joint, turning device or the like arrangements. However, it is considered to be easier and less costly to provide an arrangement which make use of the plastic deformation of a material than constructing some kind arrangement for a controlled turning motion. In a preferred embodiment the connection, the orthodontic device and the placement jig is made of the same material, e.g. plastic or metal, which makes the assembly easy to manufacture. However, due to certain demands of the different parts concerning functionality, it may be advantageous to use different material for the different parts of the orthodontic device.

Furthermore, the jig may be an integrated part of the orthodontic device. The jig and orthodontic device may be integrally moulded. Preferably, the jig is attached to an orthodontic device at or near the end of the orthodontic device which is close to the incisal edge of the tooth when the orthodontic device is attached to the tooth. The jig is adapted to be in contact with the incisal edge of the tooth so as to aligning and positioning the orthodontic device when it shall be attached to the tooth. The position may have been tried out on a model of the patients tooth beforehand but may also be tried out directly on the patient. When the orthodontic device is attached to the tooth by a desired method, e.g. by applying an adhesive on the attachment surface of the orthodontic device, the jig may be removed from the orthodontic device. Hence, the integrally manufactured device is provided with means for making it easy to adjust the jig with respect to the orthodontic device before the jig is removed from the orthodontic device. In one embodiment, the connection between the orthodontic device (e.g. a bracket) and the jig is weakened so that the jig will be loosened by bending the placement jig back and forth a couple of times. The weakening may be made by perforations, a generally weak connection or another suitable way in order to achieve a connection which easily can be broken. In still another embodiment, the connection is made by a thin rod which may be bent and twisted to achieve a desired position.

The jig is preferably of a relatively small size and is smaller or about the same size as the orthodontic device. The smaller the jig is made, the less material is wasted when the placement jig is discarded after use.

The orthodontic device may either be placed directly by hand or by the use of some kind of instrument, e.g. a gripping tool, which holds the placement jig and thus the orthodontic device, in the desired position. The device may of course be held by a tool gripping some other part of the orthodontic device in such a way that the jig only serves the purpose of indicating the position of the orthodontic device.

The above described placement jig may be used in the case of self ligating brackets. Such brackets normally comprise a base and a lid pivotally connected to the base. In this case, all the parts of the bracket may be made as one, integrally manufactured piece, e.g. by moulding, or the lid may be a separate part from the base, i.e. the lid and the base are made as separate parts and later on mounted together. In either case, the placement jig is preferably moulded integrally with the base. It would of course be possible to attach the placement jig to the lid but since it is the positioning of the base on the tooth that is essential, it is normally preferred to have the jig attached to the base.

In a specific embodiment of the placement jig, the jig is formed as a flat stick having its flat side facing the tooth.

The placement jig is preferably divided in two portions whereof the first portion is the portion which is attached to the orthodontic device at one end and at its other end it is connected to the second portion. In this case, the first portion and second portion are divided from each other via a bend and the first and second portion are bent with respect to each other at an angle of between 30 and 120 degrees, preferably between 40 and 90 degrees and most preferably between 45 and 80 degrees at a distance such that the incisal edge of the tooth shall be fitted either in the bend or on the surface of the second portion of the jig. Since the jig shall be able to be reshaped and reformed in its configuration with respect to the orthodontic device, it is also a possibility to produce a jig which may be reshaped in such a way that the angle between the first and second portion may be changed. The bend may be made as either a relatively short, sharp bending point or may be made as more smoothly curved, longer bending portion. The distance between the attachment point of the placement jig to the orthodontic device and the bending point, or bending portion, is preferably less than 1 cm, more preferably less than 0,5 cm and is commonly in the range of 1-4 mm. The second portion of the jig, e.g. the part of the jig located beyond the bending point as seen from the orthodontic device, which might serve as the part which is held by hand or by a tool when positioning the orthodontic device, has preferably a length of less than 1,5 cm and is normally around 0,5 cm or less. The total length of the jig is preferably less than 2,5 cm, more preferably less than 1,5 cm and most preferably less than 1 cm. However, the total length or the length of the second portion are not crucial to the function of the jig but may for convenience and appropriate placement be within the described dimensions. According to the construction of the present invention, there are no obvious benefits in having larger dimensions than described even though the invention might work as well outside the described lengths. There is however a disadvantage in that the larger the jig is made, the more amount of material will be wasted when discarding the placement jig. As a general rule, the length of the second portion is preferably less than three times as long as the first portion, more preferably less than twice as long and most conveniently about the same length as the first portion.

Preferably is the portion of the jig attached to the orthodontic device somewhat inclined with respect to an attachment portion, e.g. a base plate adapted to be attached to the tooth, of the orthodontic device. The attachment of the jig to the orthodontic device is preferably constructed in such a way that may be changed between 2 degrees and 90 degrees, more preferably between 5 and 60 degrees and most preferably between 10 and 45 degrees. This inclination angle makes the orthodontic device well suited for being attached to the lingual side of the tooth.

It is further preferred that the inclination of the angle of the first portion relatively the attachment portion of the orthodontic device is smaller than the bending angle between the first and second portion of the placement jig.

In a second aspect of the invention, it relates to a method and system for opening and closing the lid of a self ligating bracket. According to the invention comprises the lid a holding stick extending from the surface of the lid. The purpose of the stick is to allow a tool to get a grip around the stick and effectuating a force on the stick which in turn forces the lid to open.

In a preferred embodiment of the invention, the lid comprises a covering section and a closing section. The covering section is pivotally connected to the main portion and the covering section and the closing section are angled with respect to each other. The closing section is provided with said holding stick. In this embodiment, the angled portion will allow a good support for the tool to brace against so as to effectuate a force enough to open the lid.

In order to get a better grip, the stick may be provided with a hook, protrusion or indentation in order to allow a tool, e.g. a fork or a small rod provided with a loop at its end, to get a better grip on the stick.

According to a preferred embodiment of the invention, the stick may also be used as a holding stick when positioning the orthodontic device in order to get a better grip of the orthodontic device so as to improve the secure positioning of the orthodontic device when it is attached to a tooth. According to this embodiment, the stick may be placed on any kind of orthodontic device in order to improve the positioning of the device and not only on a self ligating bracket.

By the expression “orthodontic device” in this context is meant brackets, tubes, bite ramps or the like devices which are intended to be attached to the tooth for orthodontic treatment.

### BRIEF DESCRIPTION OF DRAWINGS

The invention will be further described in the following with reference to the annexed drawings, in which

FIG. 1 is an isometric view of a placement jig and a bracket according to the invention,

FIG. 2 is a side view of the placement jig and the bracket shown in FIG. 1.

FIG. 3 is a view from above of the placement jig and the bracket shown in FIG. 1.

### EMBODIMENT(S) OF THE INVENTION

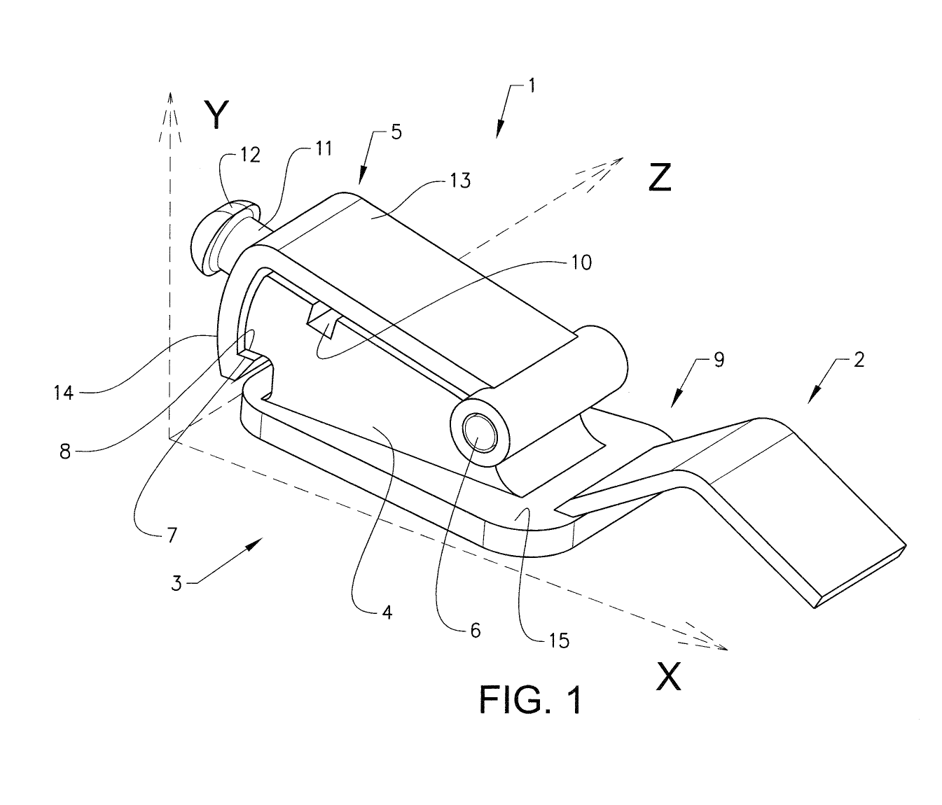

In FIGS. 1-3, there are some times used general directions or locations. The up- and down direction is defined as the Y-direction wherein the underside is the side of the device intended to be attached to a tooth and the upper side is the side facing away from the tooth when attached on a tooth. The longitudinal direction, or the length direction, is defined as the X-direction and the lateral direction, or width direction, is defined as the Z-direction.

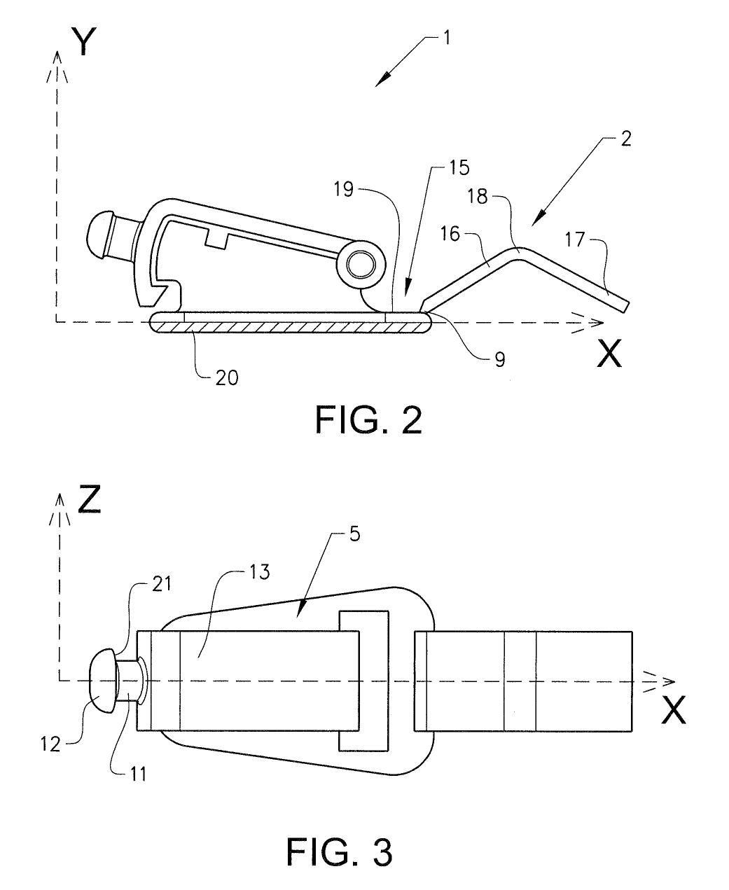

FIG. 1 shows a perspective view of an orthodontic device 1 according to the present invention. The orthodontic device comprises a placement jig 2 and a bracket 3 adapted to be attached to a tooth. The bracket 3, which in this case is a self ligating bracket, comprises a main component 4 and a lid 5. The lid 5 is pivotally connected to the main component 4 by means of a hinge 6. The bracket 3 is shown in its closed position wherein the distal end of the lid 4 is formed as a hook 7 which is adapted to engage with a shoulder 8 formed by an edge part of the main component 4. Between the bracket 3 and the jig 2 is a connection 9. The requirements of this connection is that it is rigid enough to ensure that the placement of the bracket 3 at the desired location may be performed in a satisfactorily way while at the same time be adapted to be easily broken, e.g. by bending of the jig 2 back and forth a couple of times so as to weakening the connection 9 where after the jig 2 can be detached from the bracket 3 when the bracket 3 is attached to a tooth. The main component 4 of the bracket 3 further comprises a slot 10 adapted to receive a wire or the like in order to connect brackets attached to different teeth and thereby providing an orthodontic treatment of the teeth. The lid 4 further comprises a protruding holding stick 11. The stick 11 comprises a ball end hook 12 which cross section is larger than the cross section of the stick 11 as seen along the length of the stick 11. The important feature of the hook 12 is that it is protruding on the sides of the stick 11 as can be better seen in FIG. 2. By this protruding part it will be able to disengage the lid 4 from its closed position to an open position in an easy manner as will be explained later on. The lid can be divided in two sections: a first covering section 13 which is adapted to cover the slot 10 and a closing section 14 which is provided with the closing hook 7 at its end. The stick 11 with its attached ball end hook is preferably attached to the closing section 14 of the lid 4. In this way, a tool adapted to engage with the hook, e.g. a fork shaped tool, may use the edge part of the lid 4 created at the bend of the lid between the covering section 13 and the closing section 14 to brace against so as to move the closing hook in an upwards and outwards direction in order to disengage the closing hook 7 from the shoulder 8. The bracket 3 further comprises a base plate 15 which is provided with an adhesive on its underside when the bracket is to be attached to a tooth.

In FIG. 2, which is a side view of the orthodontic device 1 shown in FIG. 1, the bent shape of the placement jig 2 can be clearly seen. The jig may be divided into two portions: a first attachment portion 16 and a second indicating portion 17 divided by a bend 18. The angle of the bend 18 between the first portion 16 and the second portion 17 is around 60 degrees in this embodiment. As can be seen in this figure as well, the upper side of the attachment portion 16 is bent, or cut off, so as to form the connection 9. The bend, or cut off, will make the attachment portion 16 thin at the connection 9 and will make it easy to bend the placement jig 2 back and forth so as to disengage from the bracket 3. In this embodiment, the angle of inclination of the attachment portion 16 with respect to the base plate 15 is around 20 degrees. However, at the attachment of the first portion 16 to the base plate at the connection 9, the inclination is steeper and the overall inclination angle of the first portion 16 with respect to the base plate will be between 25-30 degrees as taken along a line from the attachment connection 9 to the bend 18. The fact that the first portion 16 is inclined with respect to the base plate 15 makes the placement jig 2 particularly suitable to be fastened on the lingual side of a tooth. An inclination will allow the bracket 3 to be securely attached to a tooth and make it easy to positioning the bracket 3 at a desired location on the lingual surface of a tooth. In addition, the placement jig 2 is attached to the base plate 15 on its upper side 19 which is advantageous since there is less risk that the placement jig 2 will interact negatively at the time of attachment of the base plate 15 to the tooth. For example, if the placement jig 2 would be located on the edge portion of the base plate 15 and the bracket's underside 20 is to be glued onto the surface of the tooth, a part of the jig 2 may be glued to the tooth as well and thereby complicating the disengagement of the jig 2. Furthermore, the jig 2 may also interfere negatively when the bracket 3 shall be positioned on the surface of the tooth by being in contact with the tooth so as to hinder desired positioning of the base plate 15 on the surface of the tooth.

The placement jig 2 and the bracket 3 are preferably connected to each other in such a way that the jig 2 may be bent or turned in relation to the bracket, e.g. by being turned in a pivotal motion around a rotation axis parallel to the Z-axis. By being able to adjust the angle between the placement jig 2 and the base plate 15 it will be easier to locate the bracket 3 on a desired distance from the incisal edge of the tooth whereupon the bracket 3 is intended to be attached. Furthermore, the jig 2 is preferably connected to the bracket 3 in such a way that it is also possible to turn or bend the jig 2 relative to the bracket 3 around an axis parallel to the X-axis. By this motion it will be possible to induce a desired angular difference between the jig and 2 and the base plate 15 in such a way that it will become easier to position the bracket on a tooth in a desired position. Hence, the jig 2 and bracket 3 shall be connected to each other in such a way that it is easy to adjust their relations in order to make it easier to place the bracket 3 in a desired position at a desired location on the tooth. This flexibility of the relation between the jig 2 and the bracket 3 may for example be achieved by selecting a material which is flexible enough to allow some bending and turning of the jig 2, while the connection between the jig 2 and the bracket is deformed plastically, before the connection is broken.

FIG. 3 is the best figure to show how the principles of the holding stick 11. As can be seen in this view, the ball end hook 12 is wider than the stick so that an edge is created between the stick 11 and the ball end hook 12. When the edge is formed as shown in this figure, it would be easy to use a fork shaped tool in order to open the lid 5. The distance between two of the prongs of the fork shall be larger than the width of the stick 11 but narrower than the width of the part of the ball end hook creating the edge 21. The ball end stick 12 may of course be wider, or having a larger diameter, than the stick 11 in all directions but when using a fork shaped tool for opening of the lid, the essential feature is that the ball end hook 12 is wider in the Z-direction as shown in FIG. 3.

Now mainly referring to FIG. 1, the opening of the lid will be explained. When opening the lid 5, the fork is placed on top of the lid 5 with the stick 11 located between a pair of tongs of the fork tool in such a way that the tongs engages with the edge parts 21 (see FIG. 3) at each side of the stick 11 as seen in the width direction (Z-direction). The handle of the fork is pressed downwards whereby the fork braces against the bend of the lid 4 (i.e. the part defined between the covering section 13 and the closing section 14). The fork work as a lever arm and will cause a force to work through the stick 11 on the closing section 14 of the lid, and thus the closing hook 7, in such a way that the hook 7 moves away from the shoulder 8.

However, other tools might be used which works according to the same principle, e.g. a loop formed tool or the like, which may be threaded over the ball end hook and engage with the stick. In that case, it would be preferable to have a hook with a protruding edge on the lower side of the stick in the Y-direction as defined in the figures so as to form an edge there which engages with the loop shaped tool. Hence, there are several possibilities of shaping tools adapted to fit for hooks on a disengaging stick in one or the other way. It shall also be noted that a hook on the stick may as well be made as an indentation, cut, notch or the like as well as other type of hooks, e.g. an eye hook, barb or any other suitable hook.

Furthermore, the tool may be adapted to get a grip on a plain stick why it is not necessary to provide the stick with any hook at all. However, this implies that a more advance tool having moving parts, e.g. a pair of tongs, might be needed.

The invention is not limited to the embodiments which is described above, but may be varied within the scope of the appended claims.

In particular, it shall be noted that the figures only refers to self ligating brackets. It would of course also be possible to use this method for other kinds of brackets or orthodontic devices as well.

It shall also be noted that the placement jig and the holding stick not necessary must be used on the same device but may be used separately, e.g. it is possible to use the placement jig for a self ligating bracket without the holding stick or for an ordinary bracket which is not self ligating. Likewise, the holding stick may be used on a self ligating bracket which is not provided with the placement jig.

However, these two features combined make the bracket easier to position and handle and it is preferred to incorporate these two features on the same device. As already described, there is a synergistic effect of using them together in that the stick may be used to hold the orthodontic device in a desired position while the jig is used to indicate the desired position.

1. An orthodontic device comprising:
A component adapted to be attached to a tooth
A placement jig
A connection between said component and said placement jig
wherein
the placement jig and the component are connected to each other in such a way that the jig may be bent or turned in relation to the orthodontic device, before the jig is detached from the orthodontic device, in such a way that the orthodontic device easily may be located on the tooth at a desired location
said connection being provided with means for detaching of the placement jig from the component so as to enable detachment of the placement jig when the component is attached to the tooth

2. An orthodontic device according to claim 1 wherein the connection between said placement jig and said component is changed by plastically deforming a material forming part of the connection.

3. An orthodontic device according to claim 1 wherein said placement jig is an integral part of said component and attached to said component at a connection.

4. An orthodontic device according to claim 1 wherein said component comprises a base plate, said base plate being adapted to be attached to a surface of a tooth, and a main portion adapted to be used as a tool in orthodontic treatment.

5. An orthodontic device according to claim 4 wherein said jig is attached to said main portion (4) by said connection (9).

6. An orthodontic device according to claim 4 wherein said placement jig is connected to said base plate by said connection.

7. An orthodontic device according to claim 6 wherein said placement jig at its connection to said base plate is connected to the upper side of said base plate.

8. An orthodontic device according to claim 7 wherein said placement jig at its connection is inclined with respect to the surface of said base plate.

9. An orthodontic device according to claim 8
wherein the angle of inclination between said placement jig and said base plate at its connection is between 2 degrees and 90 degrees, more preferably between 5 and 60 degrees and most preferably between 10 and 45 degrees.

10. An orthodontic device according to claim 1 wherein said placement jig is divided in two portions, a first attachment portion and a second indicating portion divided by a bend, said portions are bent with respect to each other at an angle of between 30 and 120 degrees, preferably between 40 and 90 degrees and most preferably between 45 and 80 degrees at a distance such that the incisal edge of the tooth shall be fitted either in the bend or on the surface of the second portion of the jig.

11. An orthodontic device according to claim 1 wherein said orthodontic device is provided with a holding stick.

12. An orthodontic device according to claim 11 wherein said holding stick comprises a hook.

13. An orthodontic device according to claim 1 wherein the orthodontic device is a self ligating bracket comprising a main portion and a lid, said lid being pivotally connected to said main portion and said lid comprises a holding stick which extends from the surface of the lid.

14. A self ligating bracket according to claim 13 wherein that said lid comprises a covering section and a closing section wherein the covering section is pivotally connected to said main portion, the covering and the closing section are angled with respect to each other, said closing section being provided with a holding stick.

15. A self ligating bracket according to claim 14 wherein said holding stick comprises a hook.

16. An orthodontic device according to claim 2 wherein said placement jig is an integral part of said component and attached to said component at a connection.
